(19) United States
(12) Patent Application Publication
(10) Pub. No.: US 2013/0021415 A1
(43) Pub. Date: Jan. 24, 2013

(54) Ink Delivery Agitation System

(71) Applicants: Casey Walker, Boulder, CO (US); Carl Bildstein, Lafayette, CO (US); Timothy Bradley, Longmont, CO (US)

(72) Inventors: Casey Walker, Boulder, CO (US); Carl Bildstein, Lafayette, CO (US); Timothy Bradley, Longmont, CO (US)

(21) Appl. No.: 13/184,936

(22) Filed: Jul. 18, 2011

(51) Int. Cl. B41J 2/175

(52) U.S. Cl. 347/85

(57) ABSTRACT

An ink delivery system is disclosed. The ink delivery system includes one or more subtanks to store ink and an agitation system coupled to each of the one or more subtanks to vibrate a subtank to prevent ink particles from settling in the subtank.

### FIELD OF THE INVENTION

This invention relates generally to the field of ink jet printing systems. More particularly, the invention relates to delivering ink to a print engine within an ink jet printing system.

### BACKGROUND

An ink jet printer is an example of a printing apparatus that ejects droplets of ink onto a recording medium, such as a sheet of paper, for printing an image on the recording medium. The ink jet printer includes a print engine having one or more ink jet print heads provided with an ink cartridge that accommodates the ink. In operation of the print engine the ink is supplied from an ink delivery system to ejection nozzles of each print head so that a printing operation is performed by ejection of the ink droplets from selected ejection nozzles.

In ink jet printers implementing suspended solids inks (e.g., Magnetic Ink Character Recognition (MICR) inks), the suspended ink particulate may settle in subtanks, resulting in clogs or coagulated particulate within the ink delivery system. Such clogs or coagulated material create problems with ink flow to the print heads, which requires service personnel to spend additional time manually cleaning the ink delivery system.

Therefore, a mechanism to prevent particles from settling in an ink delivery system is desired.

### SUMMARY

In one embodiment, an ink delivery system is disclosed. The ink delivery system includes one or more subtanks to store ink and an agitation system coupled to each of the one or more subtanks to vibrate a subtank to prevent ink particles from settling in the subtank

In another embodiment, an agitation unit is disclosed. The agitation unit is includes a bracket to mount on an ink subtank, a vibration unit mounted on the bracket to vibrate the subtank to prevent ink particles from settling in the subtank and an air pressure input mounted on the bracket to provide an air supply to the vibration unit.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a print engine; and

FIG. 3 illustrates one embodiment of an ink delivery system; and

FIG. 4 illustrates one embodiment of an agitation unit.

### DETAILED DESCRIPTION

An ink delivery system is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

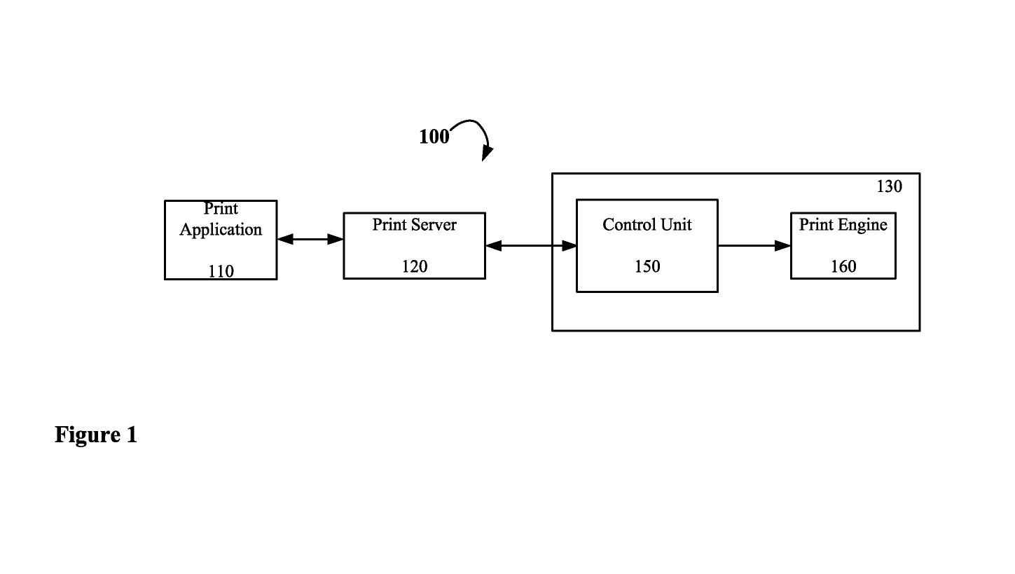

FIG. 1 illustrates one embodiment of a printing system 100. Printing system 100 includes a print application 110, a server 120 and a printer 130. Print application 110 makes a request for the printing of a document. Print server 120 processes pages of output that mix all of the elements normally found in presentation documents, e.g., text in typographic fonts, electronic forms, graphics, image, lines, boxes, and bar codes.

Print server 120 subsequently communicates with printer 130. Printer 130 includes a control unit 140 and a print engine 160. Control unit 150 receives print jobs into printer 130. Further, control unit 150 processes and renders objects received from print server 120 and provides sheet maps for printing to print engine 160. Moreover, control unit 150 may include processing logic that may include hardware (e.g., circuitry, dedicated logic, programmable logic, microcode, etc.), software (such as instructions run on a processing device), or a combination thereof.

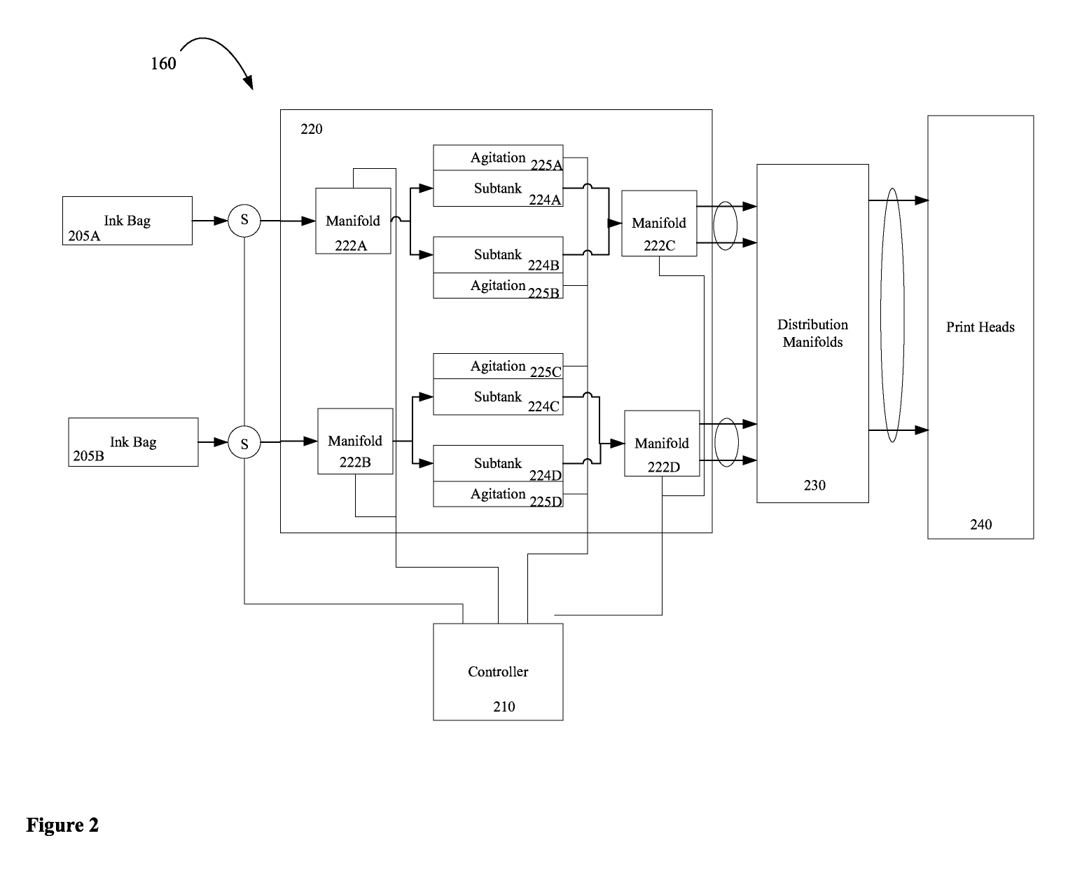

Print engine 160 provides an imaging process to mark a printable recording medium (e.g., paper). In one embodiment, print engine 160 includes forty print heads, each having fourteen hundred nozzles. However, other embodiments of print engine 160 may be implemented. FIG. 2 illustrates one embodiment of print engine 160, which includes ink bags 205, controller 210, ink delivery system 220, distribution manifolds 230 and print heads 240.

Ink bags 205A and 205B provides the supply of ink to print heads 240 via ink delivery system 220 under the control of controller 210. Controller 210 activates a corresponding solenoid and input manifold 222 to allow ink to flow into subtanks 225 at ink delivery system 220. Whenever ink is needed at print heads 240, controller 210 activates one or more of output manifolds 222 to allow ink flow to print heads 240 from subtanks 224 via distribution manifolds 230.

However when no ink is being delivered to print heads 230, the ink sits in the subtanks 224. As discussed above, suspended ink particulate may settle in subtanks 224 during this time, resulting in clogs or coagulated particulate within ink delivery system 220. According to one embodiment, an agitation unit 225 is coupled to each subtank 224 to provide a vibration to prevent ink particles from settling in a subtank 224.

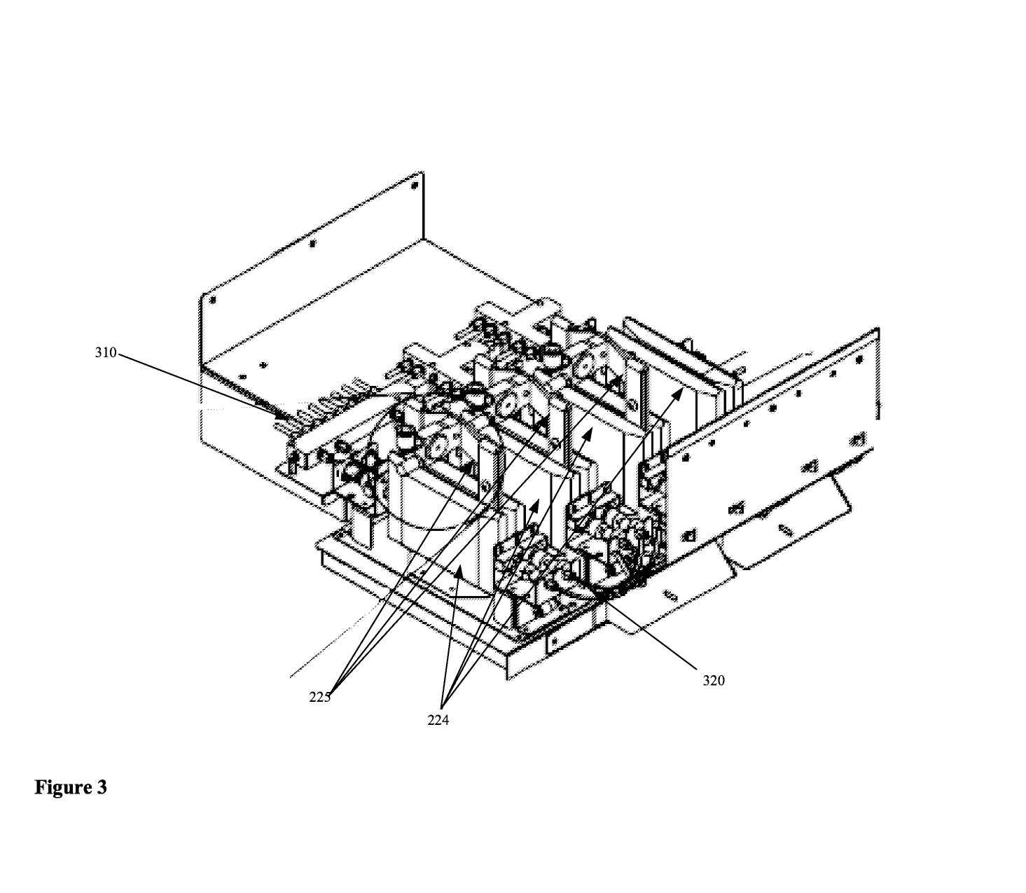

FIG. 3 illustrates one embodiment of an ink delivery system 220. Ink delivery system 220 includes ink supply lines 310 that receive ink from ink bags 205, as well as ink supply lines that 320 what supplies ink to print heads 230. Also shown in FIG. 3 are subtanks 224. In one embodiment, each subtank 224 is comprised of non-elastic bags that prevent expansion and contraction regardless of volume of ink. Additionally, each subtank 224 has an agitation unit 225 mounted on top.

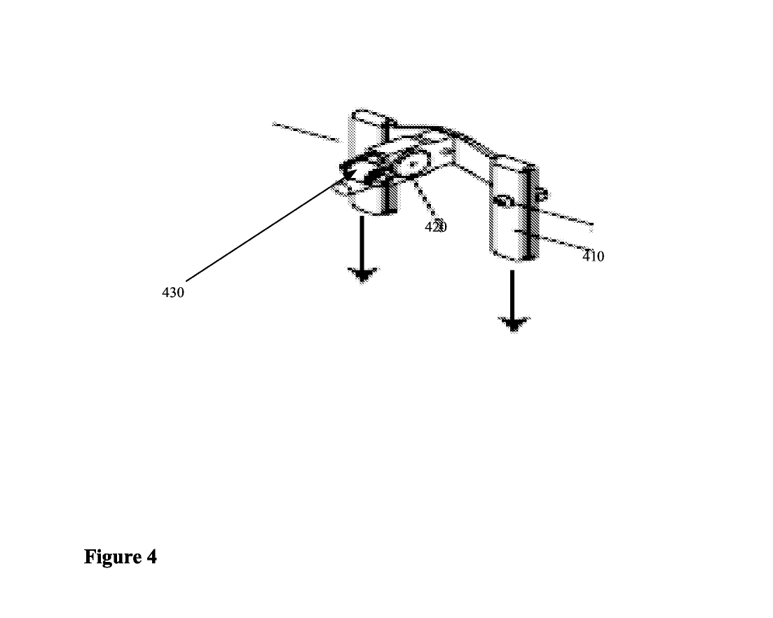

FIG. 4 illustrates one embodiment of an agitation unit 225. Agitation unit 225 includes a bracket 410 that is implemented to mount agitation unit 225 to a subtank 224. Agitation unit 225 also includes a vibration unit 420 and air pressure input 430. Vibration unit 420 vibrates subtank 224 using air received at air pressure input 430. In one embodiment, the vibration frequency of vibration unit 420 is adjusted via input air pressure received at air pressure input 430.

However in other embodiments, vibration frequency of vibration unit 420 may also be adjusted by changing the distance of the momentum arm of agitation unit 225 (e.g., height of vibration unit 420 relative to subtank 224). In yet another embodiment, vibration unit 420 may be put into motion using other forms of power (e.g., electrical, fluid, etc.).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A printer comprising:
an ink jet print head having a plurality of nozzles to mark a printable recording medium with ink; and
an ink delivery system, including:
one or more subtanks to store ink for delivery to the print head; and
an agitation system coupled to each of the one or more subtanks to vibrate a subtank to prevent ink particles from settling in the subtank.

2. The printer of claim 1, wherein the agitation system comprises an agitation unit mounted on each of the one or more subtanks.

3. The printer of claim 2, wherein the agitation unit comprises:
a mounting system to attach to the subtank;
a vibration unit attached by the mounting system; and
an energy source to provide actuation energy to the vibration unit.

4. The printer of claim 3, wherein a vibration frequency for the vibration unit is adjusted by controlling the amount of energy provided to the vibration unit.

5. The printer of claim 3, wherein a vibration frequency for the vibration unit is adjusted by changing a distance of a momentum arm of the agitation unit.

6. The printer of claim 1, wherein the ink delivery system further comprises a controller to control the flow of ink from the one or more subtanks to the print head.

7. The printer of claim 6, further comprising one or more ink bags to provide ink to the ink delivery system under control of the controller.

8. The printer of claim 7, wherein the ink delivery system further comprises one or more input manifolds coupled between the one or more ink bags and the one or more subtanks.

9. The printer of claim 8, wherein the ink delivery system further comprises one or more output manifolds coupled between the one or more subtanks and the print head.

10. The printer of claim 9, further comprising one or more distribution manifolds coupled between one or more output manifolds and the print head.

11. An ink delivery system comprising:
one or more subtanks to store ink; and
an agitation system coupled to each of the one or more subtanks to vibrate a subtank to prevent ink particles from settling in the subtank.

12. The ink delivery system of claim 11, further comprising an agitation unit mounted on each of the one or more subtanks.

13. The ink delivery system of claim 12, wherein the agitation unit comprises:
a mounting system to attach to the subtank;
a vibration unit attached by the mounting system; and
an energy source to provide actuation energy to the vibration unit.

14. The ink delivery system of claim 13, wherein a vibration frequency for the vibration unit is adjusted by controlling the amount of energy provided to the vibration unit.

15. The ink delivery system of claim 13, wherein a vibration frequency for the vibration unit is adjusted by changing a distance of a momentum arm of the agitation unit.

16. The ink delivery system of claim 11, further comprising a controller to control the flow of ink to and from the one or more subtanks.

17. The ink delivery system of claim 16, further comprising one or more input manifolds coupled to the one or more subtanks to receive ink into the ink delivery system.

18. The ink delivery system of claim 17, further comprising one or more output manifolds coupled to the one or more subtanks.

19. An agitation unit, comprising:
a mounting system to attach to the subtank;
a vibration unit attached by the mounting system; and
an energy source to provide actuation energy to the vibration unit.

20. The agitation unit of claim 19, wherein a vibration frequency for the vibration unit is adjusted by controlling the amount of energy provided to the vibration unit.
